(19) United States
(12) Patent Application Publication
(10) Pub. No.: US 2010/0161781 A1
(43) Pub. Date: Jun. 24, 2010

(54) APPARATUS AND METHOD FOR DIGITAL HOME DOMAIN MANAGEMENT

(75) Inventors: Do-Won NAM, Daejeon (KR); Yeon Jeong Jeong, Daejeon (KR); Jee Hyun Park, Daejeon (KR); Jung Soo Lee, Daejeon (KR); Jung Hyun Kim, Daejeon (KR); Kisong Yoon, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/536,846

(22) Filed: Aug. 6, 2009

(30) Foreign Application Priority Data
Dec. 22, 2008 (KR) 10-2008-0131777

(51) Int. Cl. G06F 15/173

(52) U.S. Cl. 709/223

(57) ABSTRACT

An apparatus for digital home domain management includes a home domain server which manages in one user domain all user terminals within a home group and provides each user terminal with a domain license in contents; and a DRM coupler which provides the contents and domain licenses converted to conform to a DRM type loaded in user terminals if contents sharing is requested among user terminals loaded with different DRMs within the home group.

### CROSS-REFERENCE(S) TO RELATED APPLICATION(S)

The present invention claims priority of Korean Patent Application No. 10-2008-0131777, filed on Dec. 22, 2008, which is incorporated herein by reference.

### FIELD OF THE INVENTION

The present invention relates to digital rights management (referred to as DRM hereinafter), and, more particularly, to a method and apparatus that manages a number of user terminals loaded with different DRM technologies under a domain, receives a domain license from a domain management server of a content provider and provides contents and the domain license converted in a form appropriate for individual user terminals by coupling with DRM.

### BACKGROUND OF THE INVENTION

In general, DRM technology is a technology that prevents illegal circulation of digital contents and promotes safe circulation of digital contents and, in order to construct such DRM system encryption and decryption techniques, charge, permission to use and public-key infrastructure techniques are employed.

Domain management is a technique to share the contents among a number of terminals by managing the terminals possessed by one user in a bundled unit called a domain. In general, the domain management technique has been used to realize content sharing based on a domain among terminals loaded with an identical DRM technique. Conventional DRM-based domain management is carried out on the domain management server of a content provider (referred to as CP hereinafter) on which all the terminals on the domain are registered and managed.

When a user needs to use contents provided by a variety of CPs, however, it is difficult to manage user terminals in a uniform and consistent manner because domain management servers of CPs are managed independent of each other and, therefore, the service is limited to use only the CP which supplies the same DRM as that chosen on the user's terminal.

FIG. 1 shows a domain management method based on a conventional DRM.

It is supposed that a home group denoted by user 10 has three terminals, terminal A 20, terminal B 30 and terminal C 40, and that DRM-A is loaded on the first two, terminal A 20 and terminal B 30, whereas DRM-B is loaded on the last, terminal C 40.

In this case, the domain of user 10 that consists only of the two terminals, terminal A 20 and terminal B 30, are managed on domain server 60 of content provider 50 (hereinafter, CP) which provides DRM-A and the other terminal, terminal C 40, is not comprised in the domain since it employs DRM-B that is different from the one provided by CP 50.

If user 10 purchases contents from CP 50 using a terminal, say terminal A 20, domain server 60, issues a domain license to the terminal and, therefore, the contents can be used on terminal A thanks to the issued domain license. Any other terminals that comprise the domain can use the contents as well, since the domain license can be copied on them. A terminal, i.e., terminal C 40, of user 10 that does not comprise the domain, however, cannot use the contents even if the contents and domain license are copied and transmitted to the terminal, because it is not allowed to use the copied domain license. Conventional domain management techniques have been designed under the assumption that CP and the user's terminals are loaded with an identical DRM, and hence it is impossible to share purchased contents among the terminals loaded with different DRMs.

If there exists another CP which provides DRM-B, contents purchased from the CP could be used only on terminal C 40 with DRM-B but not on other terminals, terminal A and terminal B, loaded with DRM-A. In this case, a domain server of this CP would manage a domain that consists of terminal C 40. Note that this domain is independent of the one managed by domain server 60 mentioned in the above.

In conventional domain management techniques, different content providers comprise mutually independent domains and, hence, a user should employ separate management processes using respective CPs for domains of his terminals that are loaded with different DRM techniques.

### SUMMARY OF THE INVENTION

In view of the above, the present invention provides an apparatus and method for digital home domain management which allows sharing of license and contents among a number of user terminals loaded with different DRM techniques, wherein the domain license gets issued from the domain management server of a CP by managing in a domain all the user terminals that were subject to separate domain servers of various CPs and user terminals are supplied with the contents and domain licenses converted to conform to respective DRMs on them.

In accordance with one aspect of the present invention, there is provided an apparatus for digital home domain management, including:

a home domain server which manages in one user domain all user terminals within a home group and provides each user terminal with a domain license in contents; and

a DRM coupler which provides the contents and domain licenses converted to conform to a DRM type loaded in user terminals if contents sharing is requested among user terminals loaded with different DRMs within the home group.

In accordance with another aspect of the present invention, there is provided a method for digital home domain management, including:

managing in one user domain all user terminals within a home group;

converting a license in contents that was purchased for one of the user terminals in order to conform to each user terminal with a domain license issued for the user domain;

converting the contents to conform to each DRM type if contents sharing is requested among user terminals loaded with different DRMs; and

providing the converted domain license and contents for each user terminal within the home group.

### BRIEF DESCRIPTION OF THE DRAWINGS

The above features of the present invention will become apparent from the following description of an embodiment given in conjunction with the accompanying drawings, in which:

FIG. 1 shows a block diagram of a conventional domain management system.

FIG. 2 shows a block diagram of a domain management system in accordance with an embodiment of the present invention.

FIG. 3 shows a detailed block diagram of a home domain server and DRM coupler in accordance with an embodiment of the present invention.

### DETAILED DESCRIPTION OF THE EMBODIMENTS

Hereinafter, embodiments of the present invention will be described in detail with reference to the accompanying drawings.

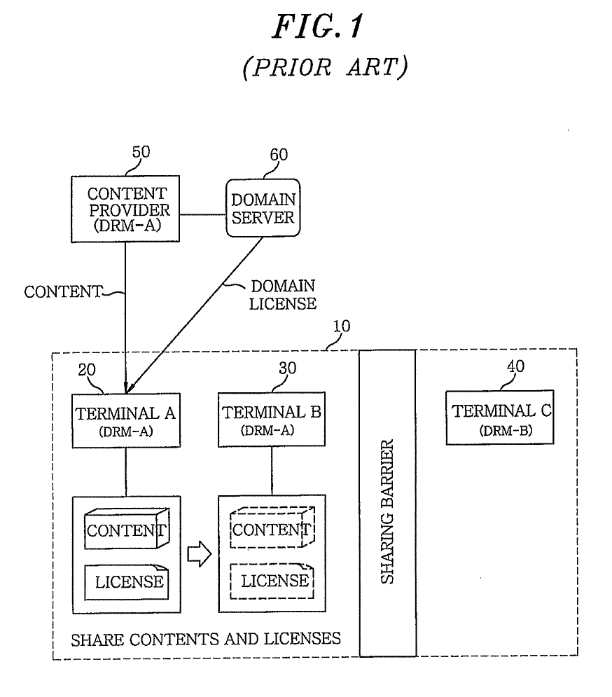

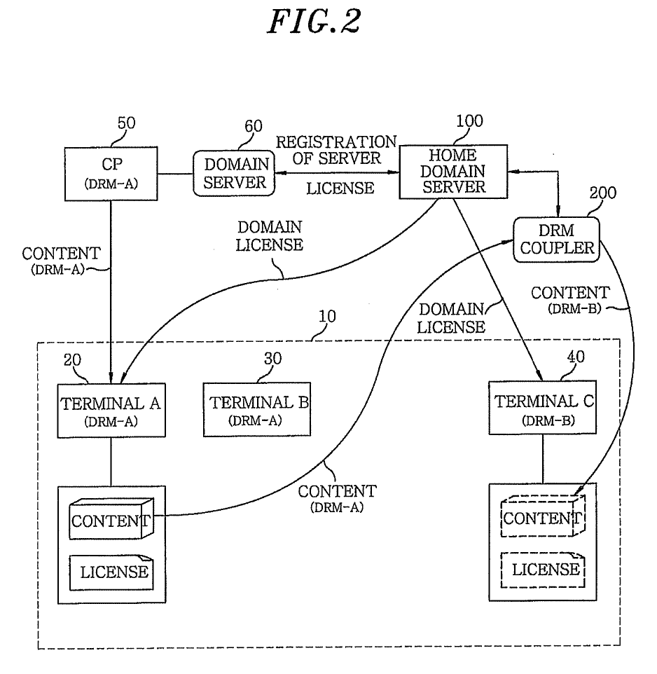

FIG. 2 shows a block diagram of a domain management system in accordance with an embodiment of the present invention. In comparison with FIG. 1, the domain management system in FIG. 2 in accordance with an embodiment of the present invention has a home domain server 100 and a DRM coupler in addition to the conventional domain management system depicted in FIG. 1.

There are two important differences between the two domain management systems. First, it is home domain server 100 in the home group of user 10 that manages the domain of user 10 in an embodiment of the present invention, whereas it is domain server 60 in CP 50 in the conventional system. Second, while, in the conventional system, domain server 60 of CP 50 manages in a domain only those terminals, terminal A 20 and terminal B 30, loaded with a DRM (DRM-A) identical to that chosen by CP 50, in an embodiment of the present invention, all terminals, terminal A, terminal B and terminal C, of user 10 are managed in a user domain irrespective of the type of DRMs loaded on them.

Suppose that user 10 purchases a content from CP 50 using terminal A 20. Then a content with DRM-A applied is transmitted from CP 50 directly to terminal A 20 as before. However, a license for DRM-A is first issued to home domain server 100 from domain server 60 of CP 50. Referring to the domain information of user 10, home domain server 100 generates a domain license in accordance with DRM-A used on a terminal A 20 and issues it to terminal A 20.

When user 10 wants to share the content on terminal A 20 loaded with DRM-A on terminal B 30 with the same DRM-A, the content and domain license are copied and transmitted to terminal B 30, and the transmitted content and license can be used without having to go through any modifications since they are of the same DRM.

When user 10 wants to share the content on terminal A 20 loaded with DRM-A on terminal C 40 with a different DRM, say DRM-B, the content with DRM-A applied is converted to a content with DRM-B applied through DRM coupler 200 and then transmitted to terminal C 40. Terminal C 40 requests home domain server 100 for the license in the content to be issued. Home domain server 100, referring to the domain information of user 10, generates a domain license in accord with DRM-B used on terminal C 40 and then issues it to terminal C 40. Because the content and domain license transmitted to terminal C 40 has been converted to conform to DRM-B loaded on itself, terminal C 40 can use the content.

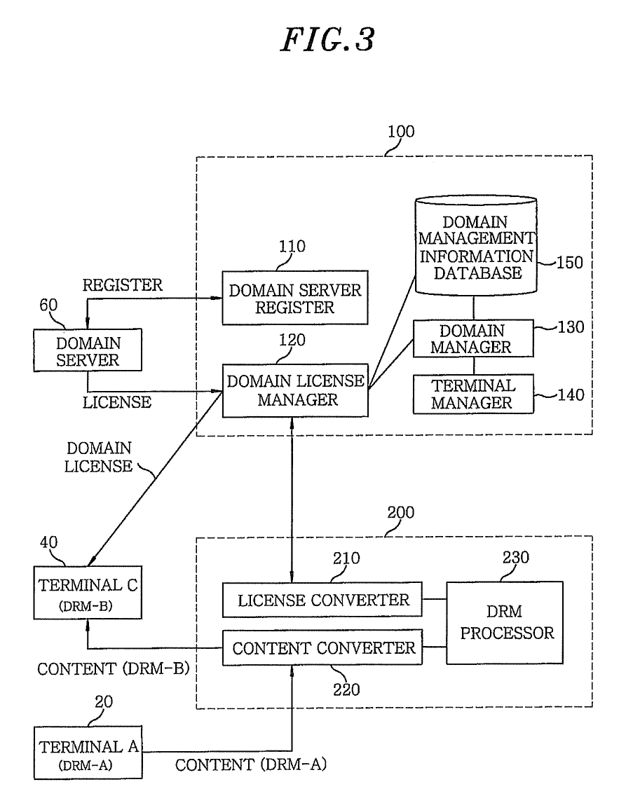

FIG. 3 shows a detailed block diagram of a home domain server 100 and DRM coupler 200 in a digital home domain management system in accordance with an embodiment of the present invention. Home domain server 100 comprises a domain server register 110, a domain license manager 120, a domain manager 130, a terminal manager 140 and a domain management information database 150, whereas DRM coupler 200 comprises a license converter 210, a content converter 220 and a DRM processor 230.

Respective components of home domain server 100 shall be explained in detail by referring to FIG. 3.

Home domain server 100 consists of a terminal manager 140 that identifies, authenticates and manages terminals of the user, a domain manager 130 that determines the domain comprises of which terminals, a domain management information database 150 that stores information about the terminals and domain, a domain server register 110 that registers home domain server 100 on domain server 60, and a license manager 120 that generates and issues a domain license to the terminals in the domain using the license issued from domain server 60 of CP 50.

Domain manager 140 identifies, authenticates and manages terminals of the user and extracts from the respective terminals information about the DRMs loaded on them to pass to domain manager 130.

Domain manager 130 generates, deletes and manages the user domain based on the terminal information passed from terminal manager 140 and records on domain management information database 150 the domain setting information including which terminal belongs to which domain and which DRMs are loaded on the respective terminals on the domain.

Domain server register 110 registers home domain server 100 on domain server 60 of CP 50 to take over the role as the domain license issuer played by domain server 60 of conventional CP 50. Once home domain server 100 is registered on domain server 60 of CP 50, domain server 60 of CP 50 relegates the issuing service of domain licenses to home domain server 100.

Domain license manager 120 generates, using the license issued from domain server 60 of CP 50, the domain license based on the domain information of the respective user terminals and the terminal information that reside on domain management information database 150 and then issues the domain license to the user terminals. Using domain management information database 150, domain license manager 120 finds which type of the DRM is loaded on the user terminal for which the domain license is to be issued and license converter 210 of DRM coupler 200 is used to convert to a domain license that is appropriate for the terminal.

On domain management information database 150 are stored and managed the information about identification, authentication and DRM of the terminals managed by terminal manager 140, the information about the domain generated in domain manager 130 and the terminal information on the domain. It is also a storage where domain license manager 120 records the license issued from domain server 60 of CP 50.

Respective components of DRM coupler 200 shall be explained in detail by referring to FIG. 3.

DRM coupler 200 consists of a content converter 220 that converts a content between different DRMs, a license converter 210 that converts a license between different DRMs and a DRM processor 230 that includes DRM modules necessary to apply and remove DRMs in various converters for content and license conversions.

Content converter 220 is used to convert a content with DRM-A applied to that with DRM-B applied. Content converter 220 is given the content from user terminal A 20 on which DRM-A is loaded, releases DRM-A applied on the content using DRM processor 230, applies DRM-B instead and delivers the content to user terminal C on which DRM-B is loaded.

License converter 210 converts the license in conformance with the DRM of the user terminal to which the domain license is to be issued, when the license issued from domain server 60 of CP 50 needs to be issued in the form of a domain license to a user terminal using a DRM different from that in domain server 60.

License converter 210 receives the license information from domain license manager 120, converts using DRM processor 230 and then returns the converted license information back to domain license manager 120. Domain license manager 120 generates the domain license for the user terminal using the converted license information and passes to the user terminal.

DRM processor 230 includes DRM packager and unpackager modules used in content converter 220 as well as a permission language conversion module. It provides all processing modules necessary for use in the course of DRM coupling.

While the invention has been shown and described with respect to the embodiment, it will be understood by those skilled in the art that various changes and modifications may be made without departing from the scope of the invention as defined in the following claims.

What is claimed is:

1. An apparatus for digital home domain management, comprising:
a home domain server which manages in one user domain all user terminals within a home group and provides each user terminal with a domain license in contents; and
a DRM coupler which provides said contents and domain licenses converted to conform to a DRM type loaded in user terminals if contents sharing is requested among user terminals loaded with different DRMs within said home group.

2. The apparatus for digital home domain management of claim 1, wherein said home domain server includes:
a domain server register that registers said home domain server on the domain server of content provider which provides said contents;
a domain license manager that generates a domain license in said contents to conform to each user terminal within said home group;
a terminal manager that manages information of said user terminal; and
a domain manager that manages domain information of said user terminal and information of said user terminal collected by said terminal manager.

3. An apparatus for digital home domain management of claim 2, wherein said domain license manager identifies a type of DRM loaded on said user terminal, generates said domain license so as to conform to the type of DRM on said user terminal, and issues it to a corresponding user terminal.

4. The apparatus for digital home domain management of claim 2, wherein said domain manager is equipped with a domain management information database where domain information as well as terminal information of said each user terminal is stored.

5. The apparatus for digital home domain management of claim 4, wherein said terminal information is identification information, authentication information or DRM type information of each user terminal.

6. The apparatus for digital home domain management of claim 1, wherein said DRM coupler includes:
a license converter that converts said domain license to conform to the type of DRM of said each user terminal;
a contents converter that converts said contents to conform to the type of DRM of said each user terminal; and
a DRM processor that converts, with said license converter and contents converter, said contents and domain license to conform to a DRM type loaded in each user terminal if contents sharing is requested among user terminals loaded with different DRMs within said home group.

7. The apparatus for digital home domain management of claim 6, wherein said license converter identifies DRM information of the corresponding user terminal if a domain license is requested by an arbitrary user terminal within said home group, and converts said domain license to conform to DRM of said user terminal if DRM on said user terminal is different from that in said domain license.

8. The apparatus for digital home domain management of claim 6, wherein said contents converter identifies DRM information of the corresponding user terminal if said content is requested to be shared by an arbitrary user terminal within said home group, and converts said content to conform to DRM of said user terminal if DRM on said user terminal is different from that applied to said content.

9. The apparatus for digital home domain management of claim 1, wherein said contents are produced so as to be reproduced through a license by a contents supplier on a wired-and-wireless communication net.

10. The apparatus for digital home domain management of claim 9, wherein said license is a domain license that all user terminals within said home group can use.

11. The apparatus for digital home domain management of claim 10, wherein said domain license is integratively issued from a domain server of said contents supplier to said home domain server.

12. A method for digital home domain management, comprising:
managing in one user domain all user terminals within a home group;
converting a license in contents that was purchased for one of said user terminals in order to conform to each user terminal with a domain license issued for said user domain;
converting said contents to conform to each DRM type if contents sharing is requested among user terminals loaded with different DRMs; and
providing said converted domain license and contents for each user terminal within said home group.

13. The method for digital home domain management of claim 12, wherein said domain license converting includes:
receiving a domain license request from arbitrary user terminals within said home group;
identifying DRM information of the user terminal requesting said domain license; and
converting said domain license to conform to the DRM on said user terminal if the DRM on said user terminal is different from that of said domain license.

14. The method for digital home domain management of claim 12, wherein said domain license converting includes:
receiving a said contents sharing request from arbitrary user terminals within said home group;
identifying DRM information of the user terminal requesting said contents sharing; and
converting said contents to conform to the DRM on said user terminal if the DRM on said user terminal is different from that applied to said contents.

15. The method for digital home domain management of claim 12, wherein said user domain managing manages terminal information of all user terminals within said home group on a database.

16. The method for digital home domain management of claim 15, wherein said terminal information is identification information, authentication information or DRM type information of each user terminal.

17. The method for digital home domain management of claim 12, wherein said contents are produced so as to be reproduced through a license by a contents supplier on a wired-and-wireless communication net.

18. The method for digital home domain management of claim 17, wherein said license is a domain license that all user terminals within said home group can use.
